(19) United States
(12) Patent Application Publication
(10) Pub. No.: US 2010/0088625 A1
(43) Pub. Date: Apr. 8, 2010

(54) TABLET PC AND FULL-SCREEN KEYBOARD WINDOW DISPLAY METHOD THEREOF

(75) Inventor: Feng-Shan CHEN, Taipei (TW)

Correspondence Address: LOWE HAUPTMAN HAM & BERNER, LLP, 1700 DIAGONAL ROAD, SUITE 300, ALEXANDRIA, VA, 22314, US

(73) Assignee: INVENTEC CORPORATION, Taipei (TW)

(21) Appl. No.: 12/429,673

(22) Filed: Apr. 24, 2009

(30) Foreign Application Priority Data
Oct. 7, 2008 (TW) 097138533

(51) Int. Cl. G06F 3/048

(52) U.S. Cl. 715/773

(57) ABSTRACT

A tablet PC includes a processing unit and a display panel. The display panel is controlled by the processing unit and for displaying an application program window and selectively displaying a full-screen keyboard window of which the transparency is higher than the transparency of the application program window.

### METHOD THEREOF

This application claims the benefit of Taiwan application Serial No. 97138533, filed Oct. 7, 2008, the subject matter of which is incorporated herein by reference.

### BACKGROUND OF THE INVENTION

1. Field of the Invention

The invention relates in general to a tablet PC and a full-screen keyboard window display method thereof, and more particularly to a tablet PC providing high convenience and a full-screen keyboard window display method thereof.

2. Description of the Related Art

Tablet PC is a notebook computer and has been widely used in many fields. A pure flat tablet PC does not have an annexed keyboard but provides a stylus for the user to input through hand writing or a screen small keyboard provided by Microsoft OS. However, the low recognition rate in hand-writing input makes the tablet PC inefficient in input. Compared with conventional keyboard input, to input through the screen small keyboard is slow and inconvenient and is disadvantageous to the execution of modifier key function.

### SUMMARY OF THE INVENTION

The invention is directed to a tablet PC and a full-screen keyboard window display method thereof. A full-screen keyboard window is displayed on the display panel, such that the user can directly operate on the display panel, and convenience of use is improved.

According to a first aspect of the present invention, a tablet PC including a processing unit and a display panel is provided. The display panel controlled by the processing unit displays an application program window and selectively displays a full-screen keyboard window, wherein the transparency of the full-screen keyboard window is higher than that of the application program window.

According to a second aspect of the present invention, the method of displaying a full-screen keyboard window on a tablet PC is provided. The tablet PC includes a processing unit and a display panel. The method includes the following steps. An application program is displayed on the display panel. A full-screen keyboard window is selectively displayed on the display panel, wherein the transparency of the full-screen keyboard window is higher than that of the application program window.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of a tablet PC according to a preferred embodiment of the invention;

FIG. 2 shows the display of a tablet PC according to a preferred embodiment of the invention;

FIG. 3 shows the display of a tablet PC and an external display device according to a preferred embodiment of the invention; and

FIG. 4 shows a part of the method of displaying a full-screen keyboard window on a tablet PC according to a preferred embodiment of the invention.

### DETAILED DESCRIPTION OF THE INVENTION

The invention provides a tablet PC and a full-screen keyboard window display method thereof. A full-screen keyboard window is displayed on the display panel, such that the user can directly operate on the display panel and improve convenience of use.

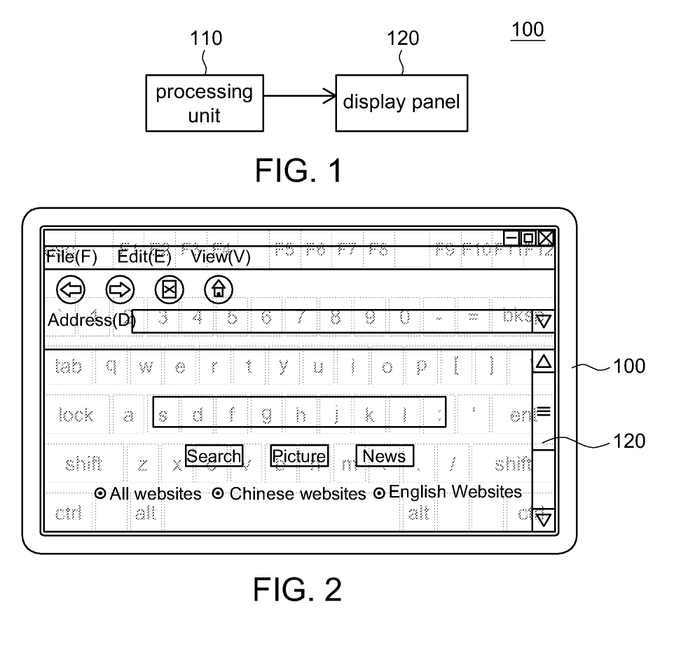

Referring to FIG. 1, a block diagram of a tablet PC according to a preferred embodiment of the invention is shown. The tablet PC 100 includes a processing unit 110 and a display panel 120. The processing unit 110 executes an operating system (OS), which substantially generates an application program window and selectively generates a full-screen keyboard window. The display panel 120, controlled by the processing unit 110, displays the application program window and selectively displays the full-screen keyboard window, wherein the transparency of the full-screen keyboard window is higher than that of the application program window. Whether the display panel 120 displays the full-screen keyboard window is determined by a switch button which can be an icon of the OS. The switching speed of the window can be improved by way of hardware.

Referring to FIG. 2, the display of a tablet PC according to a preferred embodiment of the invention is shown. In FIG. 2, the display panel 120 of the tablet PC 100 simultaneously displays an application program window and a full-screen keyboard window, wherein the full-screen keyboard window covers the application program window. The full-screen keyboard window substantially is in a half-transparent mode, such that when the user operates through the full-screen keyboard window, the application program window is visible to the user, and the convenience of use is improved. As the virtual keyboard is expanded to the full screen, the user can operate the display panel 120 with two hands, which is indeed handy and convenient. Meanwhile, the user operates the virtual keyboard as if operating a conventional keyboard.

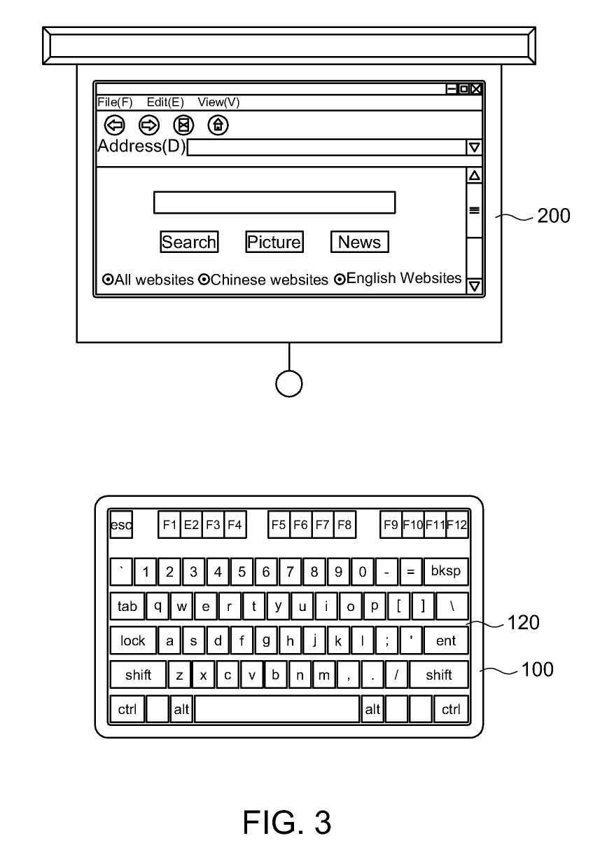

Besides, if the tablet PC 100 is connected to an external display or an external projector, the user can use the tablet PC 100 as a conventional keyboard without having to prepare a physical keyboard. Referring to FIG. 3, the display of a tablet PC and an external display device according to a preferred embodiment of the invention is shown. In FIG. 3, the tablet PC 100 is coupled to an external display device 200, wherein the external display device 200 displays the application program window, and the display panel 120 of the tablet PC 100 displays the full-screen keyboard window. Meanwhile, the full-screen keyboard window is in a non-transparent mode, so the tablet PC 100 can be used as a conventional keyboard.

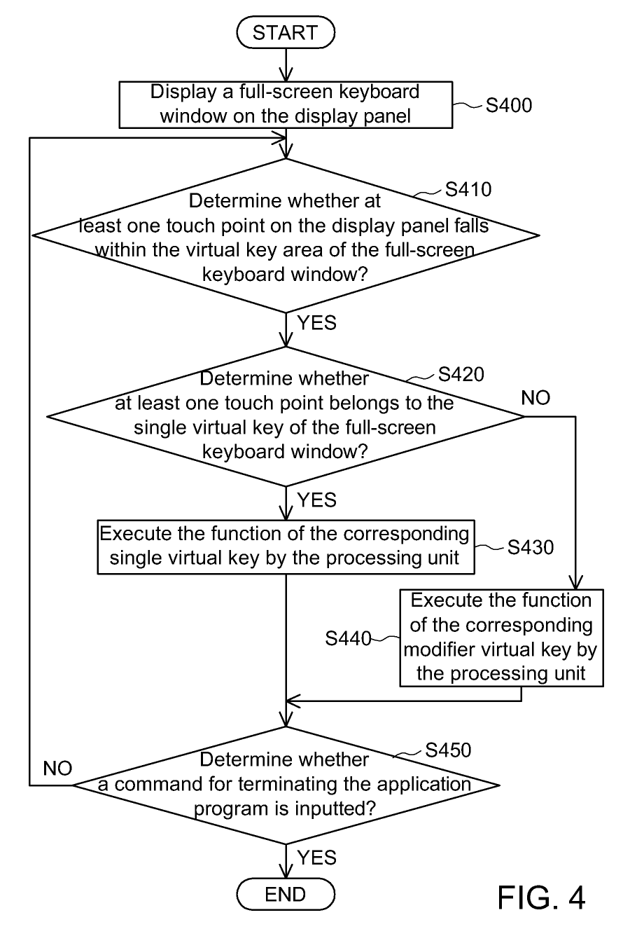

On the part of the abovementioned tablet PC 100, the display panel 120 preferably is a multi-point touch panel, such that the full-screen keyboard window can be used to execute the single virtual key function or the modifier virtual key function. Referring to FIG. 4, a part of the method of displaying a full-screen keyboard window on a tablet PC according to a preferred embodiment of the invention is shown. The method begins at step S400, a full-screen keyboard window is displayed on the display panel. Next, the method proceeds to step S410, whether at least one touch point on the display panel falls within the virtual key area of the full-screen keyboard window is determined. In step S410, the processor of the tablet PC substantially retrieves the coordinate array of the at least one touch point on the display panel from the driver of the multi-point touch display panel by way of polling so as to determine whether these touch points fall within some virtual key areas of the full-screen keyboard window.

If at least one touch point falls within the virtual key area of the full-screen keyboard window, then the method proceeds to step S420, whether at least one touch point belongs to the single virtual key of the full-screen keyboard window is determined. If at least one touch point belongs to the single virtual key of the full-screen keyboard window, then the method proceeds to step S430, the function of the corresponding single virtual key, such as an alphabetic key function, a numeric key function or a functional key function, is executed by the processing unit. If at least one touch point respectively belongs to many virtual keys of the full-screen keyboard window, then the method proceeds to step S440, the function of the corresponding modifier virtual key is executed by the processing unit.

In the above step S430 and step S440, the processing unit substantially determines the virtual key function according to the scan code fed-back by the full-screen keyboard window. Then, the method proceeds to step S450, whether a command for terminating the application program is inputted is determined. If a command for terminating the application program is inputted, then the full-screen keyboard window is closed, otherwise the method returns to step S410 to retrieve the coordinate array of the at least one touch point on the display panel after a time interval.

According to the tablet PC and the full-screen keyboard window display method thereof disclosed in the above embodiment of the invention, a full-screen keyboard window is displayed on a display panel of the tablet PC, such that the user can directly operate on the display panel with two hands without using a stylus, hence improving convenience of input. Besides, if the tablet PC is connected to an external display device, then the tablet PC can further be used as a conventional keyboard, and there is no need to bring a conventional keyboard, largely increasing convenience of use.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A tablet PC, comprising:
a processing unit; and
a display panel, controlled by the processing unit, for displaying an application program window and selectively displaying a full-screen keyboard window, wherein the transparency of the full-screen keyboard window is higher than the transparency of the application program window.

2. The tablet PC according to claim 1, wherein when the display panel displays the full-screen keyboard window, the full-screen keyboard window covers the application program window, and the full-screen keyboard window is in a half-transparent mode.

3. The tablet PC according to claim 1, wherein if the tablet PC is coupled to an external display device, then the external display device displays the application program window, the display panel displays the full-screen keyboard window, and the full-screen keyboard window is in a non-transparent mode.

4. The tablet PC according to claim 1, wherein the full-screen keyboard window is controlled by a switch button to be selectively displayed on the display panel.

5. The tablet PC according to claim 1, wherein the display panel is a multi-point touch panel.

6. The tablet PC according to claim 5, wherein when the display panel displays the full-screen keyboard window, the tablet PC determines whether at least one touch point on the display panel falls within the virtual key area of the full-screen keyboard window.

7. The tablet PC according to claim 6, wherein if the at least one touch point falls within the virtual key area of the full-screen keyboard window, then the tablet PC determines whether the at least one touch point belongs to the single virtual key of the full-screen keyboard window.

8. The tablet PC according to claim 7, wherein if the at least one touch point belongs to the single virtual key of the full-screen keyboard window, then the processing unit executes the function of the corresponding single virtual key, otherwise, the processing unit executes the function of the corresponding modifier virtual key.

9. The tablet PC according to claim 8, wherein the single virtual key function comprises a functional key function.

10. A method of displaying a full-screen keyboard window on a tablet PC, wherein the tablet PC comprises a processing unit and a display panel, and the method comprises:
displaying an application program on the display panel; and
selectively displaying a full-screen keyboard window on the display panel, wherein the transparency of the full-screen keyboard window is higher than the transparency of the application program window.

11. The method according to claim 10, wherein when the display panel displays the full-screen keyboard window, the full-screen keyboard window covers the application program window, and the full-screen keyboard window is in a half-transparent mode.

12. The method according to claim 10, further comprising:
coupling the tablet PC to an external display device;
displaying the application program window on the external display device; and
displaying the full-screen keyboard window on the display panel, wherein the full-screen keyboard window is in a non-transparent mode.

13. The method according to claim 10, wherein the full-screen keyboard window is selectively displayed on the display panel by a switch button.

14. The method according to claim 10, wherein the display panel is a multi-point touch panel.

15. The method according to claim 14, further comprising:
determining whether at least one touch point on the display panel falls within the virtual key area of the full-screen keyboard window when the display panel displays the full-screen keyboard window;
determining whether the at least one touch point belongs to the single virtual key of the full-screen keyboard window if the at least one touch point falls within the virtual key area of the full-screen keyboard window; and
executing the function of the corresponding single virtual key by the processing unit if the at least one touch point belongs to the single virtual key of the full-screen keyboard window, and executing the function of the corresponding modifier virtual key otherwise by the processing unit if the at least one touch point does not belong to the single virtual key of the full-screen keyboard window.

16. The method according to claim 15, wherein the single virtual key function comprises a functional key function.
